(19) United States
(12) Patent Application Publication
(10) Pub. No.: US 2025/0208542 A1
(43) Pub. Date: Jun. 26, 2025

(54) FIXING DEVICE AND IMAGE FORMING APPARATUS

(71) Applicant: FUJIFILM Business Innovation Corp., Tokyo (JP)

(72) Inventors: Hideki KUGE, Kanagawa (JP); Yasushi NAGATA, Kanagawa (JP); Takayuki YAMASHITA, Kanagawa (JP); Makoto OCHIAI, Kanagawa (JP); Takayuki UKAWA, Kanagawa (JP)

(73) Assignee: FUJIFILM Business Innovation Corp., Tokyo (JP)

(21) Appl. No.: 18/747,465

(22) Filed: Jun. 19, 2024

(30) Foreign Application Priority Data
Dec. 25, 2023 (JP) 2023-217986

(51) Int. Cl. G03G 15/20; G03G 15/00

(52) U.S. Cl. CPC G03G 15/2032; G03G 15/2064; G03G 15/50

(57) ABSTRACT

A fixing device includes a first pressing unit and a second pressing unit that are provided to be able to come into contact with each other and to be separated from each other and that rotate with a recording material, on which an unfixed image is formed, interposed therebetween to feed the recording material while applying a pressure to the recording material, a changing unit that changes a pressure between the first pressing unit and the second pressing unit, a first pressing driving unit that rotationally drives the first pressing unit, a second pressing driving unit that rotationally drives the second pressing unit, and a control unit that controls the changing unit, the first pressing driving unit, and the second pressing driving unit, in which the control unit causes the changing unit to change the pressure after stopping rotational driving operations performed by the first pressing driving unit and the second pressing driving unit.

### CROSS-REFERENCE TO RELATED APPLICATIONS

This application is based on and claims priority under 35 USC 119 from Japanese Patent Application No. 2023-217986 filed Dec. 25, 2023.

### BACKGROUND

### (i) Technical Field

The present invention relates to a fixing device and an image forming apparatus.

### (ii) Related Art

Disclosed in JP2016-136241A is a pressure device that applies a pressure to a sheet-shaped medium with an image carrier formed on a portion of a surface of the sheet-shaped medium, the pressure device including a first pressing unit and a second pressing unit that are able to approach each other and to be separated from each other and of which at least one rotates with the sheet-shaped medium sandwiched between the pressing units to feed the sheet-shaped medium while applying a pressure to the sheet-shaped medium, a control unit that controls a driving unit such that a distance between the first pressing unit and the second pressing unit is made equal to a set target value, and a target setting unit that sets the target value. The target setting unit sets a first distance, which is greater than the thickness of the sheet-shaped medium, as the target value in a case where the sheet-shaped medium is not present between the first pressing unit and the second pressing unit and sets a second distance, at which a target pressure is applied to the sheet-shaped medium, as the target value in a case where the sheet-shaped medium and the image carrier are present between the first pressing unit and the second pressing unit. Accordingly, no impact is generated in a case where the sheet-shaped medium is caused to enter a space between the first pressing unit and the second pressing unit.

### SUMMARY

There is a device in which a recording material with an unfixed image formed thereon is caused to pass through a space between two pressing units that rotate so that the unfixed image is fixed. For example, in a case where control, in which a pressure between the two pressing units is changed depending on the type of a recording medium on which an unfixed image is formed or a situation in which an image forming apparatus is used, is performed, the speeds of rotation of the pressing units may become different from each other. In a case where the speeds of rotation of the pressing units become different from each other, the pressing units are rubbed against each other, and for example, the pressing units are damaged.

Aspects of non-limiting embodiments of the present disclosure relate to a fixing device and an image forming apparatus that suppress damage to two pressing units that is caused in a case where a pressure between the pressing units is changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a first pressing unit and a second pressing unit that are provided to be able to come into contact with each other and to be separated from each other and that rotate with a recording material, on which an unfixed image is formed, interposed therebetween to feed the recording material while applying a pressure to the recording material, a changing unit that changes a pressure between the first pressing unit and the second pressing unit, a first pressing driving unit that rotationally drives the first pressing unit, a second pressing driving unit that rotationally drives the second pressing unit, and a control unit that controls the changing unit, the first pressing driving unit, and the second pressing driving unit, in which the control unit causes the changing unit to change the pressure after stopping rotational driving operations performed by the first pressing driving unit and the second pressing driving unit.

### BRIEF DESCRIPTION OF THE DRAWINGS

Exemplary embodiment(s) of the present invention will be described in detail based on the following figures, wherein:

FIG. 1 is a view showing an image forming apparatus to which the present exemplary embodiment is applied;

FIG. 2 is a perspective view showing the configurations of a transfer cylinder and a grasping unit;

FIG. 3 is a perspective view showing the configuration of a pressing cylinder;

FIG. 4 is a perspective view showing a state where the grasping unit grasps a recording material;

FIG. 5 is a view showing a state where a heating roll is moved to a separation position due to the operation of a position changing unit;

FIG. 6 is a view showing a state where the heating roll is moved to a contact position due to the operation of the position changing unit;

FIG. 7 is a diagram showing the functional configuration of a control unit;

FIG. 8 is a flowchart showing the flow of a process performed by the control unit; and

FIG. 9 is a graph showing a pressure between the pressing cylinder and the heating roll and a circumferential speed related to a case where the heating roll is separated after fixation is finished.

### DETAILED DESCRIPTION

### Image Forming Apparatus 1

Hereinafter, an image forming apparatus to which a present exemplary embodiment is applied will be described in detail with reference to the accompanying drawings.

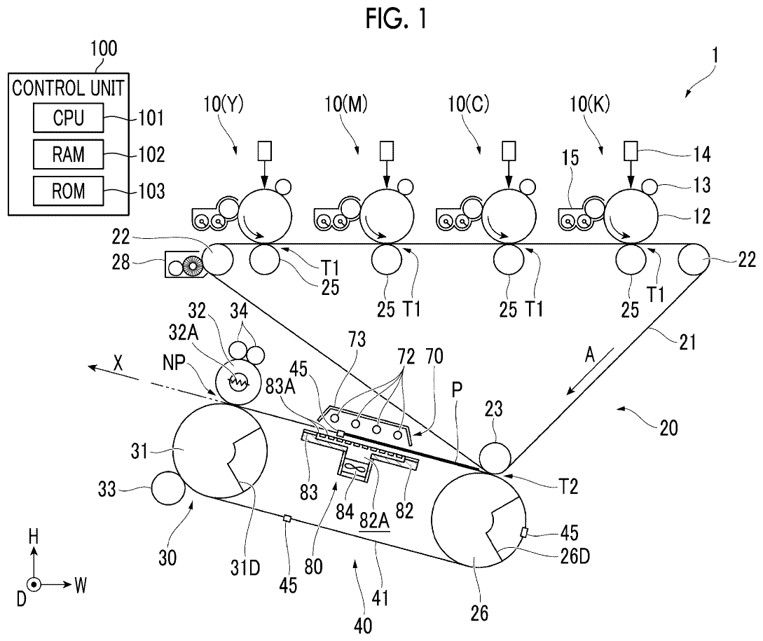

FIG. 1 is a view showing an image forming apparatus 1 to which the present exemplary embodiment is applied. The image forming apparatus 1 shown in FIG. 1 is an example of an image forming apparatus that forms a text or images on a recording material P. Examples of the image forming apparatus 1 include an electrophotographic image forming apparatus that forms a toner image on the recording material P. Note that in each drawing, an arrow H indicates a vertical direction that is an apparatus up-down direction, an arrow W indicates a horizontal direction that is an apparatus width direction, and an arrow D indicates an apparatus front-rear direction (an apparatus depth direction).

The image forming apparatus 1 includes image forming units 10 that form toner images, a transfer unit 20 that transfers the toner images formed by the image forming units 10 onto the recording material P, a fixation unit 30 that is an example of a fixing device fixing an unfixed toner image, which is an unfixed image, onto the recording material P, a transport unit 40 that transports the recording material P, and a control unit 100 that controls each unit of the image forming apparatus 1.

### Control Unit 100

The control unit 100 includes a central processing unit (CPU) 101 that controls the entire image forming apparatus 1, a random access memory (RAM) 102 that is used as a work area in the case of calculation, and a read only memory (ROM) 103 that is a memory storing various programs executed by the CPU 101, various settings, and the like.

### Image Forming Units 10

A plurality of the image forming units 10 shown in FIG. 1 are provided to form toner images of respective colors. In the present exemplary embodiment, the image forming units 10 for a total of four colors which are yellow (Y), magenta (M), cyan (C), and black (K) are provided. (Y), (M), (C), and (K) shown in FIG. 1 indicate constituent parts corresponding to the respective colors. Note that the image forming units 10 for the respective colors have the same configuration as each other except for a toner to be used. Therefore, in FIG. 1, each part of the image forming unit 10 (K), which serves as a representative of the image forming units 10 for the respective colors, is shown with a reference numeral given thereto.

Each of the image forming units 10 for the respective colors includes a photoconductor drum 12 onto which an electrostatic latent image is formed while the photoconductor drum 12 is rotating in a counterclockwise direction in FIG. 1. In addition, each of the image forming units 10 for the respective colors includes a charger 13 that charges a surface of the photoconductor drum 12, an exposure device 14 that causes the photoconductor drum 12 to be exposed to light, and a development device 15 that performs development of an electrostatic latent image formed on the photoconductor drum 12.

### Transfer Unit 20

The transfer unit 20 shown in FIG. 1 is a device that transfers a toner image formed by each image forming unit 10 to the recording material P.

The transfer unit 20 includes an intermediate transfer belt 21 on which toner images of respective colors formed on the respective photoconductor drums 12 of the image forming units 10 are transferred, and rolls 22 provided on an inner peripheral side of the intermediate transfer belt 21. In addition, the transfer unit 20 includes primary transfer rolls 25 that transfer the toner images of the respective colors of the image forming units 10 to the intermediate transfer belt 21 at primary transfer positions T1, and a facing roll 23 and a transfer cylinder 26 that collectively transfer, to the recording material P at a secondary transfer position T2, the toner images transferred onto the intermediate transfer belt 21. Furthermore, the transfer unit 20 includes a cleaner 28 that removes a toner or the like from a surface of the intermediate transfer belt 21.

The toner images are transferred to an outer peripheral surface of the intermediate transfer belt 21 from the photoconductor drums 12 for the respective colors. As shown in FIG. 1, the intermediate transfer belt 21 has an endless shape and is wound around a plurality of the rolls 22 and the facing roll 23 such that the intermediate transfer belt 21 has an inverted triangular shape as seen in a front view (as seen in the apparatus depth direction). The intermediate transfer belt 21 revolves in a direction along an arrow A as at least one of the plurality of rolls 22 is rotationally driven.

In the present exemplary embodiment, a primary transfer electric field is applied between the primary transfer rolls 25 and the photoconductor drums 12, so that the toner images formed on the photoconductor drums 12 are transferred to the intermediate transfer belt 21 at the primary transfer positions T1.

The transfer cylinder 26 is disposed to face the facing roll 23 with the intermediate transfer belt 21 interposed therebetween. The transfer cylinder 26 is provided with a recess portion 26D for accommodation of a grasping unit 45 that grasps the recording material P.

As shown in FIG. 1, the cleaner 28 is disposed on an outer peripheral side of the intermediate transfer belt 21. In a revolution direction of the intermediate transfer belt 21, the cleaner 28 is disposed downstream of the secondary transfer position T2 and is disposed upstream of the image forming units 10.

### Fixation Unit 30

The fixation unit 30 shown in FIG. 1 includes a pressing cylinder 31 and a heating roll 32 that are provided to be able to come into contact with each other and to be separated from each other and that rotate with the recording material P, on which a toner image has been formed, sandwiched therebetween to feed the recording material P while applying a pressure to the recording material P. The pressing cylinder 31 is an example of the first pressing unit, and the heating roll 32 is an example of the second pressing unit. In addition, the fixation unit 30 includes a first driving unit 33 that rotationally drives the pressing cylinder 31 and second driving units 34 that rotationally drive the heating roll 32. Note that in the present exemplary embodiment, the heating roll 32 is rotated by two second driving units 34. However, the number of the second driving units 34 may be one or two or more. The first driving unit 33 is an example of a first pressing driving unit, and the second driving unit 34 is an example of a second pressing driving unit. Furthermore, the fixation unit 30 includes a heating unit 70 that heats the recording material P before the pressing cylinder 31 and the heating roll 32 sandwich the recording material P.

The pressing cylinder 31 has an approximately roll-like shape extending in a D direction. The pressing cylinder 31 is provided with a recess portion 31D for accommodation of the grasping unit 45.

The heating roll 32 has an approximately roll-like shape extending in the D direction. In addition, the heating roll 32 includes a heating source 32A, such as a halogen lamp, inside the roll.

As shown in FIG. 1, the pressing cylinder 31 and the heating roll 32 are disposed in an up-down direction that forms an angle with respect to a direction along an arrow H. In addition, in FIG. 1, a sandwiching region in which the pressing cylinder 31 and the heating roll 32 sandwich the recording material P is represented by a reference symbol “NP”. The sandwiching region NP is a region wide in a transport direction of the recording material P.

The first driving unit 33 transmits power from a power source (not shown) to the pressing cylinder 31 to rotate the pressing cylinder 31. In the present exemplary embodiment, for example, an electric motor is used as the power source of the first driving unit 33. The first driving unit 33 is controlled by means of the turning on/off of the electric motor, and the electric motor is turned on in a case where the pressing cylinder 31 is to be rotationally driven. In addition, the electric motor is turned off in a case where the pressing cylinder 31 is being rotationally driven by the first driving unit 33 and the pressing cylinder 31 is to stop to be rotationally driven by the first driving unit 33. In the present exemplary embodiment, stopping a power source of the first driving unit 33 suffices for the expression “to stop to be rotationally driven by the first driving unit 33” and the expression “to stop to be rotationally driven by the first driving unit 33” does not mean a state where the pressing cylinder 31 completely stops to be rotationally driven. In general, the pressing cylinder 31 continues to rotate by inertia after the power source of the first driving unit 33 is stopped.

The second driving units 34 transmit power from a power source (not shown) to the heating roll 32 to rotate the heating roll 32. In the present exemplary embodiment, for example, an electric motor is used as the power source of the second driving units 34. The second driving units 34 are controlled by means of the turning on/off of the electric motor, and the electric motor is turned on in a case where the heating roll 32 is to be rotationally driven. In addition, the electric motor is turned off in a case where the heating roll 32 is being rotationally driven by the second driving units 34 and the heating roll 32 is to stop to be rotationally driven by the second driving units 34. In the present exemplary embodiment, stopping power sources of the second driving units 34 suffices for the expression “to stop to be rotationally driven by the second driving units 34” and the expression “to stop to be rotationally driven by the second driving units 34” does not mean a state where the heating roll 32 completely stops to be rotationally driven. In general, the heating roll 32 continues to rotate by inertia after the power sources of the second driving units 34 are stopped.

In the present exemplary embodiment, the first driving unit 33 and the second driving units 34 have different power sources, and the first driving unit 33 and the second driving units 34 are individually controlled.

### Heating Unit 70

The heating unit 70 has a function of heating, in a non-contact manner, the recording material P transported in the transport direction X at the transport unit 40. The heating unit 70 is disposed upstream of the heating roll 32 in the transport direction. Accordingly, the heating unit 70 heats, in a non-contact manner, an unfixed toner image formed on a surface of the recording material P before the heating roll 32. As shown in FIG. 1, the heating unit 70 includes heaters 72 and a reflection plate 73.

The heaters 72 are heating members that heat the recording material P in a non-contact manner with respect to the recording material P transported in the transport direction X at the transport unit 40. As shown in FIG. 1, a plurality of the heaters 72 are disposed at intervals along the transport direction X. Each heater 72 is composed of, for example, a columnar infrared heater long in the D direction. Regarding the heaters 72, filaments (not shown) provided in the heaters 72 generate heat and the recording material P is heated by radiant heat thereof. In the present exemplary embodiment, four heaters 72 are provided as shown in FIG. 1, and heating is performed by a plurality of the heaters 72.

The reflection plate 73 has a function of reflecting infrared rays from the heaters 72 toward an apparatus lower side (that is, toward the recording material P transported at the transport unit 40). Specifically, the reflection plate 73 is formed in a box-like shape that is open on an apparatus lower side. The reflection plate 73 is formed by using, for example, a metal plate such as an aluminum plate.

### Transport Unit 40

The transport unit 40 has a function of transporting the recording material P such that the recording material P passes through the secondary transfer position T2 and the sandwiching region NP. The transport unit 40 includes a pair of chains 41 that is wound around the transfer cylinder 26 and the pressing cylinder 31 and that is provided on an apparatus front side and an apparatus rear side and the grasping units 45 that are attached over the pair of chains 41 and that grasp a leading end of the recording material P. In addition, the transport unit 40 includes an air blowing unit 80.

Each of the pair of chains 41 is formed in an annular shape. One of the pair of chains 41 is wound around a front end portion of the transfer cylinder 26 in the D direction and a front end portion of the pressing cylinder 31 in the D direction. In addition, the other of the pair of chains 41 is wound around a rear end portion of the transfer cylinder 26 in the D direction and a rear end portion of the pressing cylinder 31 in the D direction.

The grasping units 45 are attached over the pair of chains 41 and revolve as the pair of chains 41 revolves. A plurality of the grasping units 45 are attached to the pair of chains 41. In the present exemplary embodiment, three grasping units 45 are attached.

### Air Blowing Unit 80

The air blowing unit 80 shown in FIG. 1 faces the heating unit 70 on a side (that is, a lower side in an H direction) opposite to the heating unit 70 side (that is, an upper side in the H direction) with respect to the recording material P transported by the grasping unit 45.

The air blowing unit 80 has a function of blowing air to the lower surface of the recording material P transported by the transport unit 40. The air blowing unit 80 has a function of blowing air to the recording material P to cause the recording material P to float such that the recording material P is transported by the transport unit 40 with a rear surface of the recording material P, which is opposite to the front surface on which the toner image is formed, being in a non-contact state and has a function of maintaining the non-contact state.

In the present exemplary embodiment, the air blowing unit 80 includes a body 82, an air blowing plate 83, and an air blower 84. The body 82 includes an internal space 82A that is open upward.

The air blower 84 is provided at a lower portion of the body 82. The air blower 84 sends air to the space 82A of the body 82. As the air blower 84, for example, an axial air blower that blows air in an axial direction is used. Note that a centrifugal air blower that blows air in a centrifugal direction, such as a multi-blade air blower (for example, sirocco fans) may be used as the air blower 84.

The air blowing plate 83 is provided at an upper portion of the body 82 such that an opening of the body 82 is closed. The air blowing plate 83 faces the heating unit 70 on a side (that is, a lower side) opposite to the heating unit 70 side (that is, an upper side) with respect to the recording material P transported at the transport unit 40. Furthermore, the air blowing plate 83 is formed of a metal or a resin in a plate shape, and includes a plurality of air blowing holes 83A penetrating the air blowing plate 83 in the H direction. The air blowing plate 83 allows air, which is sent from the air blower 84 to the space 82A of the body 82, to upwardly pass through the plurality of air blowing holes 83A so that the air comes into contact with the lower surface of the recording material P, the recording material P is caused to float, and the recording material P is supported.

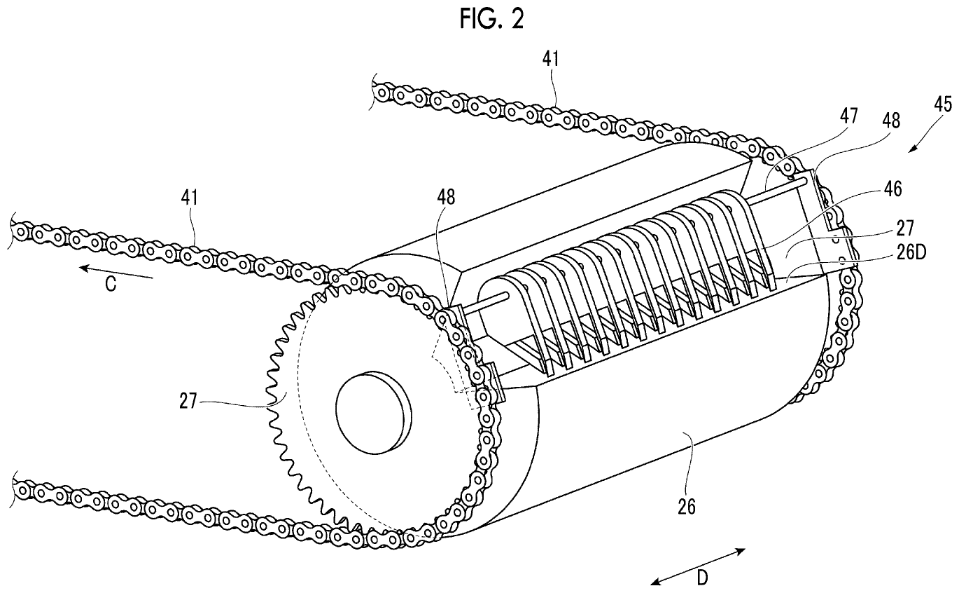

Next, the configuration of the transfer cylinder 26 and the grasping units 45 will be described in detail with reference to FIG. 2.

FIG. 2 is a perspective view showing the configurations of the transfer cylinder 26 and the grasping unit 45.

Regarding the transfer cylinder 26, a first sprocket 27 is provided at each of both ends of the transfer cylinder 26 in the axial direction.

The first sprockets 27 are disposed to be coaxial with the transfer cylinder 26 and are configured to rotate integrally with the transfer cylinder 26. Each first sprocket 27 has a disk-like shape, and a plurality of teeth over which the chain 41 is looped are provided over an end portion of the disk-like shape. Different chains 41 are wound around a pair of the first sprockets 27, respectively.

The recess portion 26D of the transfer cylinder 26 is a cutout portion having a size enough for accommodation of the grasping unit 45, and is open radially outward with respect to the transfer cylinder 26.

The grasping unit 45 is provided between the pair of chains 41 on the front side and the rear side, and the grasping unit 45 grasps and transports the recording material P. The grasping unit 45 includes a plurality of grippers 46 that hold a leading end of the recording material P, a support member 47 that supports the plurality of grippers 46, and attachment bases 48 through which the support member 47 is attached to the chains 41. The attachment base 48 is provided for each of the pair of chains 41 on the front side and the rear side.

Each gripper 46 is provided with a circular through-hole through which the support member 47 is inserted.

The support member 47 is a rod-shaped member having a circular cross section. In addition, the support member 47 is formed to have a length matching an interval between the pair of chains 41 on the front side and the rear side. The plurality of grippers 46 are fixed to the support member 47 at predetermined intervals.

The attachment bases 48 are positioned inward of the pair of chains 41 and respectively attached to links of the pair of chains 41 that face each other. One end of the support member 47 is attached to one attachment base 48, and the other end of the support member 47 with respect to the one end is attached to the other attachment base 48, so that the support member 47 is attached over the pair of chains 41.

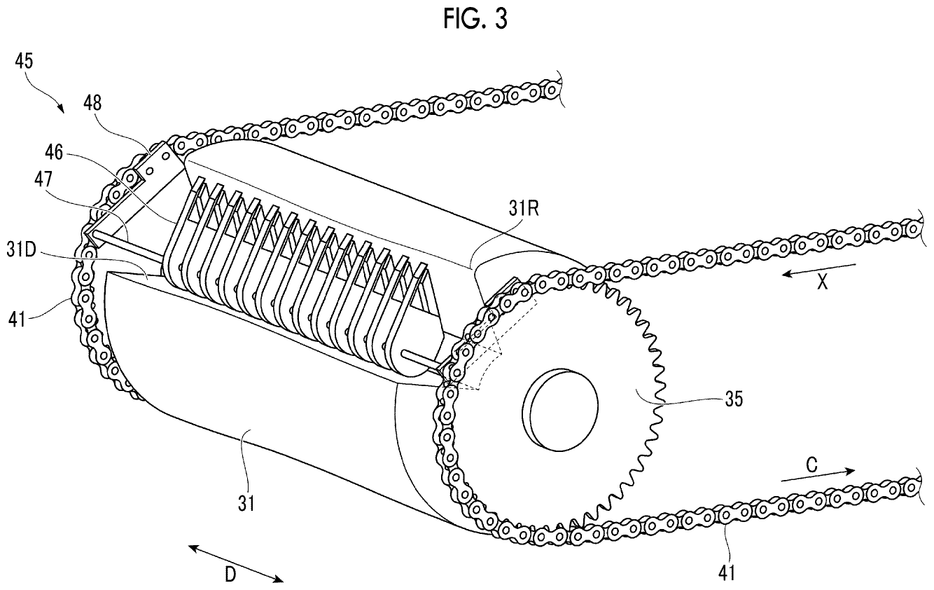

Next, the configuration of the pressing cylinder 31 will be described in detail with reference to FIG. 3.

FIG. 3 is a perspective view showing the configuration of the pressing cylinder 31.

Regarding the pressing cylinder 31, a second sprocket 35 is provided at each of both ends of the pressing cylinder 31 in the axial direction.

The second sprockets 35 are disposed to be coaxial with the pressing cylinder 31 and the second sprockets 35 are configured to rotate integrally with the pressing cylinder 31. Each second sprocket 35 has a disk-like shape, and a plurality of teeth over which the chain 41 is looped are provided over an end portion of the disk-like shape. Different chains 41 are wound around a pair of the second sprockets 35, respectively.

The recess portion 31D of the pressing cylinder 31 is a cutout portion having a size enough for accommodation of the grasping unit 45, and is open radially outward with respect to the pressing cylinder 31. A corner portion 31R is formed at an upstream end of the recess portion 31D in a rotation direction. The corner portion 31R is formed in a rounded shape, that is, a so-called R shape.

The pressing cylinder 31 has an approximately roll-like shape extending in a D direction. Regarding the shape of the pressing cylinder 31, diameters of the roll-like shape on both end portion sides in an axial direction are slightly larger than a diameter of a central portion in the axial direction. Accordingly, the circumferential speed on the end portion sides of the pressing cylinder 31 in the axial direction is higher than the circumferential speed of the central portion in the axial direction, and the recording material P pressed by the pressing cylinder 31 and the heating roll 32 is stretched to both end sides of the pressing cylinder 31, so that generation of wrinkles in the recording material P is suppressed.

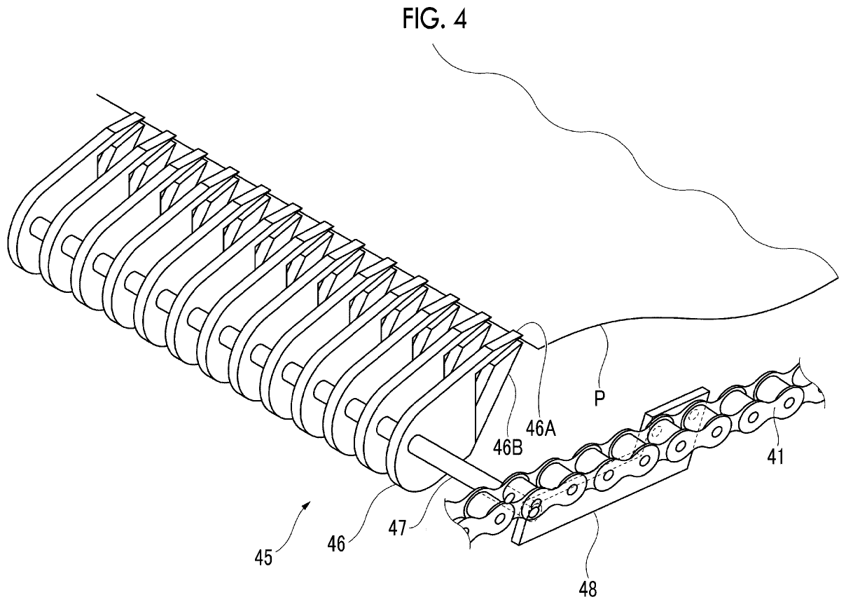

Next, a function of the grasping unit 45 that is for the grasping of the recording material P will be described with reference to FIG. 4.

FIG. 4 is a perspective view showing a state where the grasping unit 45 grasps the recording material P.

Each gripper 46 includes a claw 46A and a claw base 46B and grasps the recording material P by using the claw 46A and the claw base 46B. Note that, regarding the gripper 46, for example, the claw 46A is pressed against the claw base 46B by a spring or the like and the claw 46A is opened or closed with respect to the claw base 46B by the action of a cam or the like. The gripper 46 is disposed downstream of the recording material P in the transport direction, and holds a leading end portion of the recording material P at a position downstream of the recording material P in the transport direction.

### Position Changing Unit 90

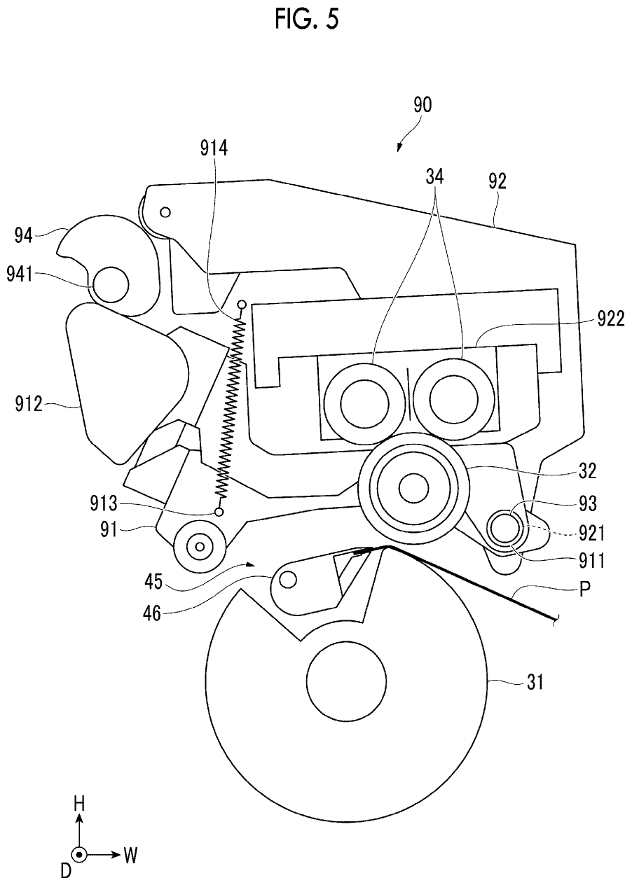

Here, the configuration of a position changing unit 90 that moves the heating roll 32 to the contact position and the separation position will be described with reference to FIG. 5.

FIG. 5 is a view showing a state where the heating roll 32 is moved to the separation position due to the operation of the position changing unit 90. At the separation position, the heating roll 32 is separated from the pressing cylinder 31. For example, in a case where the grasping unit 45 passes through a space between the pressing cylinder 31 and the heating roll 32, the heating roll 32 is at the separation position. In addition, in the present exemplary embodiment, for example, in order to prevent generation of a load that is caused due to contact between the pressing cylinder 31 and the heating roll 32, the heating roll 32 is at the separation position in a case where the image forming apparatus 1 is in a standby state. Meanwhile, at the contact position, the heating roll 32 is in contact with the pressing cylinder 31. In a case where a toner image formed on the recording material P is to be fixed, a fixing operation is performed by the pressing cylinder 31 and the heating roll 32 with the heating roll 32 being at the contact position. The position changing unit 90 functions as an example of a changing unit that changes a pressure between the pressing cylinder 31 and the heating roll 32 by moving the heating roll 32.

The position changing unit 90 supports the heating roll 32 and moves the heating roll 32 to the contact position and the separation position. The position changing unit 90 includes a lower frame 91 that supports the heating roll 32, an upper frame 92 that supports a plurality of the second driving units 34, a connection shaft 93 that connects the lower frame 91 and the upper frame 92 to each other, and a cam 94 that changes the position of the heating roll 32 through the lower frame 91.

The lower frame 91 extends in a direction along an arrow W which is a width direction of the image forming apparatus 1, and a rotation center hole 911, which is the center of rotation of the lower frame 91, is provided at one end of the lower frame 91 in the width direction. In addition, the other end of the lower frame 91 in the width direction is provided with a cam follower 912 that comes into contact with the cam 94, a spring attachment portion 913 for attachment of a spring, and a tension coil spring 914 that is attached to the spring attachment portion 913. In addition, the lower frame 91 rotatably supports the heating roll 32 on the rotation center hole 911 side in the width direction.

The rotation center hole 911 is a circular through-hole, and the connection shaft 93 is inserted into the through-hole. The rotation center hole 911 and the connection shaft 93 are not fixed and attachment is performed such that the rotation center hole 911 is made rotatable around the connection shaft 93.

The cam follower 912 is fixed to an end portion of the lower frame 91 and comes into contact with an outer circumference of the cam 94. In a case where the cam 94 is rotated, the cam follower 912 is moved around the rotation center hole 911 to match the movement of the outer circumference of the cam 94.

The spring attachment portion 913 is, for example, a columnar protrusion, and one end of the tension coil spring 914 is fixed by being wound around the spring attachment portion 913.

Regarding the tension coil spring 914, the other end of the tension coil spring 914 with respect to the one end attached to the spring attachment portion 913 is attached at a position above the position of the spring attachment portion 913 in the H direction. The tension coil spring 914 is attached in a state of being stretched such that the length thereof is made larger than the natural length of the spring. That is, the tension coil spring 914 is attached to pull up the spring attachment portion 913 upward.

The upper frame 92 includes a rotation center hole 921, which is the center of rotation of the upper frame 92, and a support portion 922 that supports the second driving units 34.

The rotation center hole 921 is a circular through-hole, and the connection shaft 93 is inserted into the through-hole. The rotation center hole 921 and the connection shaft 93 are not fixed and attachment is performed such that the rotation center hole 921 is made rotatable around the connection shaft 93.

The support portion 922 supports the second driving units 34 such that each of the second driving units 34 comes into contact with an upper portion of the heating roll 32.

The cam 94 includes a cam driving unit 941 that rotates the cam 94. The cam driving unit 941 is provided to be able to rotationally drive the cam 94 in a clockwise direction and a counterclockwise direction in FIG. 5. The cam driving unit 941 rotates clockwise and counterclockwise to control the angle of the cam 94. As the cam driving unit 941, for example, a servo motor is used. The outer circumference of the cam 94 has a plurality of portions that are different from each other in diameter from the center of rotation of the cam driving unit 941.

### About Operation of Position Changing Unit 90

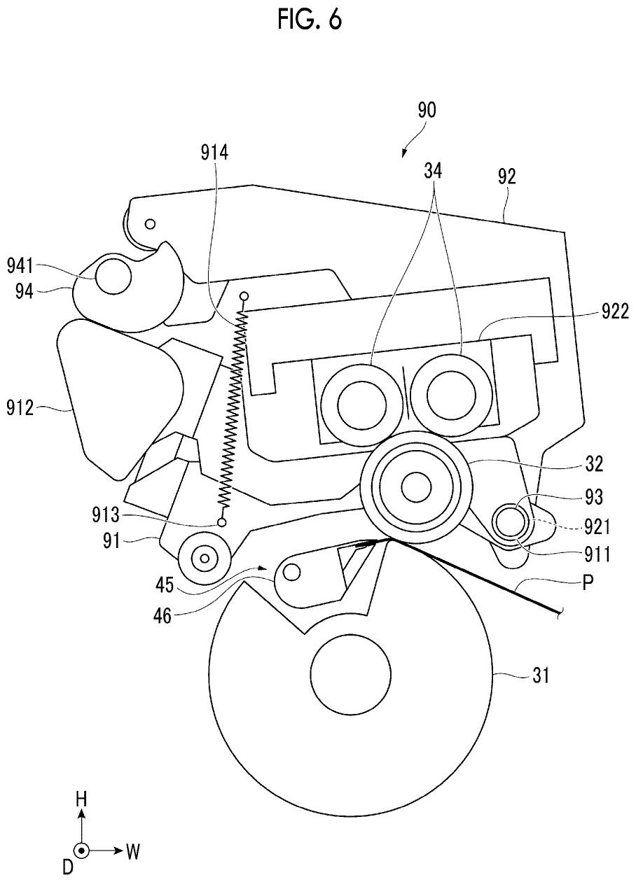

Next, the operation of the position changing unit 90 will be described with reference to FIGS. 5 and 6.

FIG. 6 is a view showing a state where the heating roll 32 is moved to the contact position due to the operation of the position changing unit 90.

In FIG. 5 described above, the recording material P transported to the sandwiching region NP (refer to FIG. 1) by the grasping unit 45 is shown. In a case where the cam 94 is rotated in the clockwise direction in FIG. 5 in a state as shown in FIG. 5, the position of contact between the cam follower 912 and the cam 94 changes, so that a large-diameter portion of the cam 94 and the cam follower 912 are brought into contact with each other as shown in FIG. 6. Since the large-diameter portion of the cam 94 presses the cam follower 912 downward, the lower frame 91 is rotated counterclockwise around the rotation center hole 911 by pressing. Accordingly, the position changing unit 90 moves the heating roll 32 from the separation position to the contact position.

In addition, in a case where the cam 94 is rotated in a counterclockwise direction in FIG. 6 in a state as shown in FIG. 6, the position of contact between the cam follower 912 and the cam 94 changes, so that a short-diameter portion of the cam 94 and the cam follower 912 are brought into contact with each other as shown in FIG. 5. Accordingly, the position changing unit 90 moves the heating roll 32 from the contact position to the separation position.

In addition, in a case where the cam 94 is further rotated in the clockwise direction in a state where the heating roll 32 is at the contact position (that is, in a state as shown in FIG. 6), the cam follower 912 is further pressed downward. The heating roll 32 is pressed against the pressing cylinder 31 and a pressure between the heating roll 32 and the pressing cylinder 31 is increased. It is possible to change a pressure applied to the recording material P by controlling the cam driving unit 941. Accordingly, for example, it is possible to change the degree of a pressure to be applied in accordance with the type of paper. Specifically, in a case where the paper type of the recording material P is plane paper, the heating roll 32 sandwiches the recording material P between the pressing cylinder 31 and the heating roll 32 at a first load. In addition, in a case where the paper type of the recording material P is coated paper, the heating roll 32 is controlled to sandwich the recording material P between the pressing cylinder 31 and the heating roll 32 at a second load greater than the first load.

### About Fixing Operation

In a state where the heating roll 32 is positioned at the separation position as shown in FIG. 5, the recording material P to which a toner image has been transferred is transported to the sandwiching region NP (refer to FIG. 1) with a leading end portion thereof held by the gripper 46. Next, as shown in FIG. 6, the pressing cylinder 31 and the heating roll 32 sandwich the recording material P transported to the sandwiching region NP. Then, the gripper 46 stops to hold the leading end portion of the recording material P. In a state where the recording material P is sandwiched between the pressing cylinder 31 and the heating roll 32, the pressing cylinder 31 and the heating roll 32 rotate to transport the recording material P. In a case where the pressing cylinder 31 and the heating roll 32 heat and press the recording material P while transporting the recording material P in a state where the recording material P is sandwiched between the pressing cylinder 31 and the heating roll 32, the toner image transferred to the recording material P is fixed onto the recording material P. In a case where fixation is finished, the position changing unit 90 moves the heating roll 32 to the separation position with the cam 94 rotating counterclockwise so that next recording material P is sandwiched, the cam 94 being shown in FIG. 6.

### Functional Configuration of Control unit

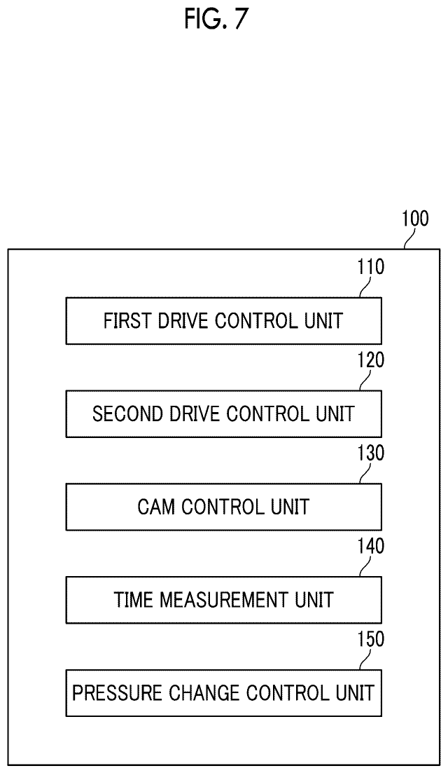

Next, a functional configuration of the control unit 100 according to the present exemplary embodiment will be described with reference to FIG. 7.

FIG. 7 is a diagram showing the functional configuration of the control unit 100.

The control unit 100 according to the present exemplary embodiment suppresses the probability of a difference between the circumferential speed of the pressing cylinder 31 and the circumferential speed of the heating roll 32 in the case of a process of changing a pressure applied between the pressing cylinder 31 and the heating roll 32.

The control unit 100 includes a first drive control unit 110 that controls the first driving unit 33, a second drive control unit 120 that controls the second driving unit 34, a cam control unit 130 that controls the angle of the cam driving unit 941, a time measurement unit 140 that measures an elapsed time after transmission of a predetermined control signal, and a pressure change control unit 150 that controls a process of changing a pressure between the pressing cylinder 31 and the heating roll 32.

The first drive control unit 110 controls an electric motor that is a driving source of the first driving unit 33. Specifically, the first drive control unit 110 controls whether to supply an electric current to the electric motor. For example, the first drive control unit 110 cuts off an electric current flowing to the electric motor so that a rotational driving operation performed by the first driving unit 33 is stopped.

The second drive control unit 120 controls an electric motor that is a driving source of the second driving units 34. Specifically, the second drive control unit 120 controls whether to supply an electric current to the electric motor. For example, the second drive control unit 120 cuts off an electric current flowing to the electric motor so that a rotational driving operation performed by the second driving units 34 is stopped.

The cam control unit 130 controls the cam driving unit 941. Specifically, the cam control unit 130 controls the rotation angle of a servo motor of the cam driving unit 941. In this manner, a pressure between the pressing cylinder 31 and the heating roll 32 is controlled.

The time measurement unit 140 measures an elapsed time after a time when the first drive control unit 110 stops a rotational driving operation performed by the first driving unit 33. In addition, the time measurement unit 140 measures an elapsed time after a time when the second drive control unit 120 stops a rotational driving operation performed by the second driving units 34. Specifically, the time measurement unit 140 detects a time when a signal issued to cut off an electric current flowing to the electric motor of the first driving unit 33 is transmitted by the first drive control unit 110 and measures the elapsed time after the detected time. In addition, the time measurement unit 140 detects a time when a signal issued to cut off an electric current flowing to the electric motor of the second driving units 34 is transmitted by the second drive control unit 120 and measures the elapsed time after the detected time.

The pressure change control unit 150 controls a process of changing a pressure between the pressing cylinder 31 and the heating roll 32. In this case, the pressure change control unit 150 performs control by using the first drive control unit 110, the second drive control unit 120, the cam control unit 130, and the time measurement unit 140. The pressure change control unit 150 is an example of a control unit that controls a changing unit, a first pressing driving unit, and a second pressing driving unit.

Specifically, the pressure change control unit 150 stops, by using the first drive control unit 110, a rotational driving operation performed by the first driving unit 33. The pressure change control unit 150 stops, by using the second drive control unit 120, a rotational driving operation performed by the second driving units 34. The pressure change control unit 150 changes a pressure between the pressing cylinder 31 and the heating roll 32 by using the cam control unit 130 after rotational driving operations performed by the first driving unit 33 and the second driving unit 34 are stopped.

In the present exemplary embodiment, the pressure change control unit 150 stops rotational driving operations performed by the first driving unit 33 and the second driving unit 34, and causes the position changing unit 90 to change a pressure between the pressing cylinder 31 and the heating roll 32 after a predetermined time elapses after the stoppage of the rotational driving operations.

Here, a time taken for inertial forces, by which the pressing cylinder 31 and the heating roll 32 are rotated, to be made small is set as the predetermined time. Specifically, the predetermined time is a time taken for a speed, at which the pressing cylinder 31 and the heating roll 32 do not rotate at different circumferential speeds, to be reached in a case where a pressure between the pressing cylinder 31 and the heating roll 32 is lowered. In addition, a time taken for the pressing cylinder 31 and the heating roll 32 to stop to rotate may be set as the predetermined time. In addition, the predetermined time may differ depending on the degree of a predetermined pressure applied between the pressing cylinder 31 and the heating roll 32. Generally, the larger a pressure applied between the pressing cylinder 31 and the heating roll 32 is, the shorter a time taken for the pressing cylinder 31 and the heating roll 32 to stop to rotate is. Therefore, a shorter time may be set as the predetermined time as a pressure applied to the pressing cylinder 31 and the heating roll 32 is higher.

The predetermined time is set, for example, based on the result of analysis obtained through an experiment or a simulation. The predetermined time is stored in, for example, a ROM 103 (refer to FIG. 1) as a setting of the image forming apparatus 1. In addition, a predetermined time received from a user may be stored in the ROM 103.

### Process Performed by Control Unit 100

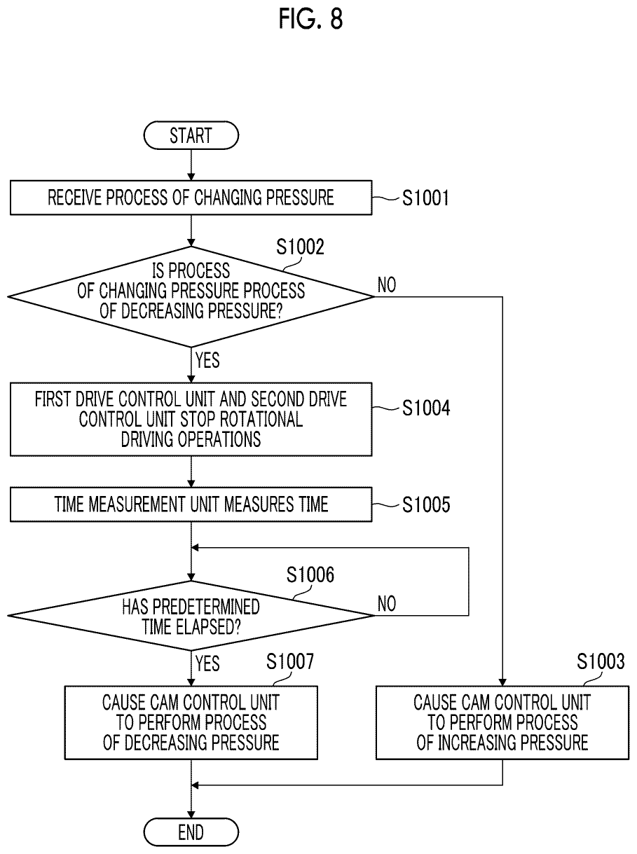

FIG. 8 is a flowchart showing the flow of a process performed by the control unit 100. Specifically, the process performed as in the flowchart of FIG. 8 is a process of moving the heating roll 32 and changing a pressure between the pressing cylinder 31 and the heating roll 32. Examples of the process include a process of moving, after fixation on one recording material P is finished, the heating roll 32 from the contact position to the separation position in order to transport the next recording material P to the sandwiching region NP.

First, the pressure change control unit 150 receives a process of changing the pressure (step S1001).

The pressure change control unit 150 determines whether or not the process of changing the pressure is a process of decreasing the pressure (step S1002). In a case where it is determined that the process of changing the pressure is not a process of decreasing the pressure (NO in step S1002), that is, in a case where it is determined that the process of changing the pressure is a process of increasing the pressure, the pressure change control unit 150 causes the cam control unit 130 to perform the process of increasing the pressure (step S1003), and the process ends.

In a case where it is determined in step S1002 that the process of changing the pressure is the process of decreasing the pressure (YES in step S1002), the first drive control unit 110 and the second drive control unit 120 stop rotational driving operations performed by the first driving unit 33 and the second driving units 34 (step S1004). Specifically, the first drive control unit 110 transmits a stoppage signal to cut off an electric current flowing to the electric motor of the first driving unit 33, and the second drive control unit 120 transmits a stoppage signal to cut off an electric current flowing to the electric motor of the second driving units 34. In the present exemplary embodiment, transmission of the stoppage signal of the first drive control unit 110 and transmission of the stoppage signal the second drive control unit 120 are synchronized with each other. Accordingly, the rotational driving operations performed by the first driving unit 33 and the second driving units 34 are stopped at the same time. The stoppage signals do not need to be transmitted strictly simultaneously and may be transmitted at different times.

In a case where the first drive control unit 110 and the second drive control unit 120 stop the rotational driving operations (step S1004), the time measurement unit 140 measures a time (step S1005). Specifically, the time measurement unit 140 detects a time at which the first drive control unit 110 and the second drive control unit 120 transmit the stoppage signals, and measures an elapsed time after the detected time point.

Next, the pressure change control unit 150 determines whether or not the predetermined time has elapsed (step S1006). In a case where it is determined that the predetermined time has not elapsed (NO in step S1006), the pressure change control unit 150 repeatedly determines whether or not the predetermined time has elapsed again and again until the predetermined time elapses.

In a case where the pressure change control unit 150 determines that the predetermined time has elapsed (YES in step S1006), the pressure change control unit 150 causes the cam control unit 130 to perform the process of decreasing the pressure (step S1007) and the process ends.

### Operation

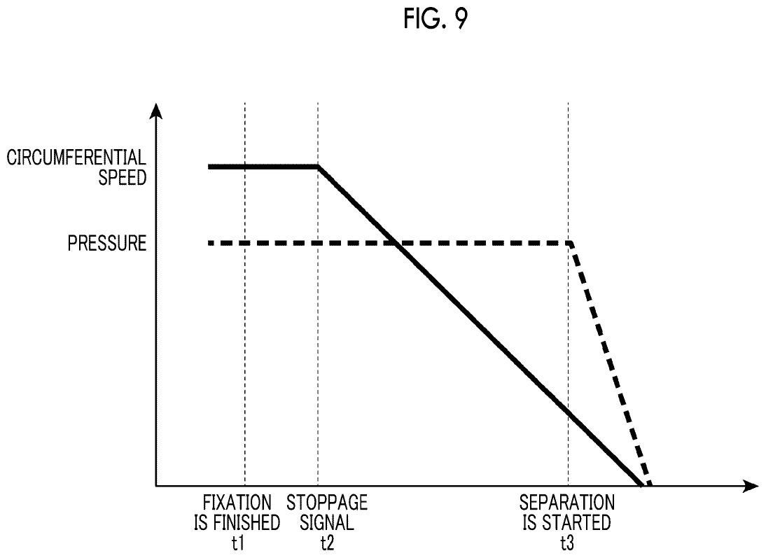

Next, operations of the present exemplary embodiment will be described with reference to FIGS. 1 and 9.

FIG. 9 is a graph showing a pressure between the pressing cylinder 31 and the heating roll 32 and a circumferential speed related to a case where the heating roll 32 is separated after fixation is finished. FIG. 9 is a graph in which the horizontal axis shows an elapsed time and the vertical axis shows the circumferential speed and the pressure.

In this graph, until time t1 is reached, the pressing cylinder 31 and the heating roll 32 rotate at the same circumferential speed in a state where the pressing cylinder 31 and the heating roll 32 are pressed, so that a toner image is fixed onto the recording material P. In addition, a pressure between the pressing cylinder 31 and the heating roll 32 and the circumferential speeds of the pressing cylinder 31 and the heating roll 32 related to a case where fixation on the recording material P is finished at time t1 and the heating roll 32 is separated for transportation of the next recording material P are shown.

Here, in a case where the fixation is finished at time t1, for the transportation of the next recording material P, the pressure change control unit 150 (refer to FIG. 7) starts control to move the heating roll 32 to the separation position.

The pressure change control unit 150 stops, at time t2, rotational driving operations performed by the first driving unit 33 and the second driving units 34. In a case where the rotational driving operations performed by the first driving unit 33 and the second driving units 34 are stopped at time point t2, the rotation speeds of the pressing cylinder 31 and the heating roll 32 gradually decrease with the pressing cylinder 31 and the heating roll 32 continuing to rotate by inertia instead of immediately stopping to rotate.

Then, in a case where the predetermined time elapses, the heating roll 32 is separated at time t3. Here, as shown in FIG. 9, the pressure between the pressing cylinder 31 and the heating roll 32 does not change during a period between time t2 and time t3. In other words, the rotational driving operations performed by the first driving unit 33 and the second driving units 34 are stopped at time t2 in a state where the pressing cylinder 31 and the heating roll 32 are pressed and then the position changing unit 90 separates the pressing cylinder 31 and the heating roll 32 from each other at time t3 which is a time reached in a case where the predetermined time elapses after time t2.

In a case where the heating roll 32 starts to be separated at time t3, the pressure between the pressing cylinder 31 and the heating roll 32 decreases. In the present exemplary embodiment, as described above, a time taken for inertial forces, by which the pressing cylinder 31 and the heating roll 32 are rotated, to be made small is set as the predetermined time. Therefore, a change in the circumferential speeds of the pressing cylinder 31 and the heating roll 32 in the case of a decrease in pressure between the pressing cylinder 31 and the heating roll 32 is suppressed.

Here, unlike the present exemplary embodiment, a case where the heating roll 32 is separated at time point t2, that is, before the predetermined time elapses will be considered. In a case where the heating roll 32 is separated at time t2, the pressure between the pressing cylinder 31 and the heating roll 32 decreases and a frictional force acting between the pressing cylinder 31 and the heating roll 32 is made small in a state where the circumferential speeds of the pressing cylinder 31 and the heating roll 32 are high. At a time immediately after time t2, the circumferential speeds of the pressing cylinder 31 and the heating roll 32 are high and thus the pressing cylinder 31 and the heating roll 32 are likely to rotate at different circumferential speeds in a case where the frictional force acting between the pressing cylinder 31 and the heating roll 32 is made small.

In the above-described exemplary embodiment, damage caused by friction between the pressing cylinder 31 and the heating roll 32 is suppressed in comparison with a case where the heating roll 32 is separated from the pressing cylinder 31 immediately after fixation is finished.

In the present exemplary embodiment, the heating roll 32 is separated each time printing on one recording material P is performed. However, the pressure change control unit 150 according to the present exemplary embodiment may also be applied to an image forming apparatus in which printing is consecutively performed on a plurality of the recording materials P without separation of the heating roll 32. For example, the pressure change control unit 150 may be applied to a case where a pressing pressure is changed depending on the type of the paper. In addition, for example, the pressure change control unit 150 of the present exemplary embodiment may be applied to a case where the heating roll 32 is separated for the purpose of decreasing a load acting between the pressing cylinder 31 and the heating roll 32 in the case of a transition to a standby state after the end of a printing job. Accordingly, occurrence of damage due to friction between the pressing cylinder 31 and the heating roll 32 is suppressed.

### Supplementary Note

(((1)))

A fixing device comprising:
a first pressing unit and a second pressing unit that are provided to be able to come into contact with each other and to be separated from each other and that rotate with a recording material, on which an unfixed image is formed, interposed therebetween to feed the recording material while applying a pressure to the recording material;
a changing unit that changes a pressure between the first pressing unit and the second pressing unit;
a first pressing driving unit that rotationally drives the first pressing unit;
a second pressing driving unit that rotationally drives the second pressing unit; and
a control unit that controls the changing unit, the first pressing driving unit, and the second pressing driving unit,
wherein the control unit causes the changing unit to change the pressure after stopping rotational driving operations performed by the first pressing driving unit and the second pressing driving unit.
   (((2)))

The fixing device according to (((1))),
wherein the control unit stops the rotational driving operations performed by the first pressing driving unit and the second pressing driving unit and causes the changing unit to change the pressure after a predetermined time elapses after the stoppage of the rotational driving operations.
   ((3))

The fixing device according to (((2))),
wherein the control unit stops the rotational driving operations performed by the first pressing driving unit and the second pressing driving unit in a state where the first pressing unit and the second pressing unit are pressed and causes the changing unit to separate the first pressing unit and the second pressing unit from each other after the predetermined time elapses after the stoppage of the rotational driving operations.
   (((4)))

The fixing device according to (((3))),
wherein a time taken for the first pressing unit and the second pressing unit to stop to rotate is set as the predetermined time.
   (5)

The fixing device according to (((3))) or (((4))),
wherein the first pressing unit and the second pressing unit are pressed at a predetermined pressure in a case where the control unit stops the rotational driving operations performed by the first pressing driving unit and the second pressing driving unit, and
the predetermined time differs depending on a degree of the predetermined pressure.
   (((6)))

The fixing device according to any one of (((1))) to (((5))
wherein the control unit is able to individually control the first pressing driving unit and the second pressing driving unit.
   (((7))

The fixing device according to ((6)
wherein the control unit stops the rotational driving operations performed by the first pressing driving unit and the second pressing driving unit at the same time.
   (((8)))

An image forming apparatus comprising:
a unit that forms an unfixed image on a recording material; and
the fixing device according to any one of (((1))) to (7))) that fixes, onto the recording material, the unfixed image formed on the recording material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a first pressing unit and a second pressing unit that are provided to be able to come into contact with each other and to be separated from each other and that rotate with a recording material, on which an unfixed image is formed, interposed therebetween to feed the recording material while applying a pressure to the recording material;
a changing unit that changes a pressure between the first pressing unit and the second pressing unit;
a first pressing driving unit that rotationally drives the first pressing unit;
a second pressing driving unit that rotationally drives the second pressing unit; and
a control unit that controls the changing unit, the first pressing driving unit, and the second pressing driving unit,
wherein the control unit causes the changing unit to change the pressure after stopping rotational driving operations performed by the first pressing driving unit and the second pressing driving unit.

2. The fixing device according to claim 1,
wherein the control unit stops the rotational driving operations performed by the first pressing driving unit and the second pressing driving unit and causes the changing unit to change the pressure after a predetermined time elapses after the stoppage of the rotational driving operations.

3. The fixing device according to claim 2,
wherein the control unit stops the rotational driving operations performed by the first pressing driving unit and the second pressing driving unit in a state where the first pressing unit and the second pressing unit are pressed and causes the changing unit to separate the first pressing unit and the second pressing unit from each other after the predetermined time elapses after the stoppage of the rotational driving operations.

4. The fixing device according to claim 3,
wherein a time taken for the first pressing unit and the second pressing unit to stop to rotate is set as the predetermined time.

5. The fixing device according to claim 3,
wherein the first pressing unit and the second pressing unit are pressed at a predetermined pressure in a case where the control unit stops the rotational driving operations performed by the first pressing driving unit and the second pressing driving unit, and
the predetermined time differs depending on a degree of the predetermined pressure.

6. The fixing device according to claim 1,
wherein the control unit is able to individually control the first pressing driving unit and the second pressing driving unit.

7. The fixing device according to claim 6,
wherein the control unit stops the rotational driving operations performed by the first pressing driving unit and the second pressing driving unit at the same time.

8. An image forming apparatus comprising:
a unit that forms an unfixed image on a recording material; and
the fixing device according to claim 1 that fixes, onto the recording material, the unfixed image formed on the recording material.

9. An image forming apparatus comprising:
a unit that forms an unfixed image on a recording material; and
the fixing device according to claim 2 that fixes, onto the recording material, the unfixed image formed on the recording material.

10. An image forming apparatus comprising:
a unit that forms an unfixed image on a recording material; and
the fixing device according to claim 3 that fixes, onto the recording material, the unfixed image formed on the recording material.

11. An image forming apparatus comprising:
a unit that forms an unfixed image on a recording material; and
the fixing device according to claim 4 that fixes, onto the recording material, the unfixed image formed on the recording material.

12. An image forming apparatus comprising:
a unit that forms an unfixed image on a recording material; and
the fixing device according to claim 5 that fixes, onto the recording material, the unfixed image formed on the recording material.

13. An image forming apparatus comprising:
a unit that forms an unfixed image on a recording material; and
the fixing device according to claim 6 that fixes, onto the recording material, the unfixed image formed on the recording material.

14. An image forming apparatus comprising:
a unit that forms an unfixed image on a recording material; and
the fixing device according to claim 7 that fixes, onto the recording material, the unfixed image formed on the recording material.
